(19) United States
(12) Patent Application Publication
(10) Pub. No.: US 2008/0114988 A1
(43) Pub. Date: May 15, 2008

(54) METHOD AND SYSTEM FOR EXCHANGING DATA BETWEEN DEVICES

(76) Inventors: Michael G. Lisanke, Durham, NC (US); Cristian Medina, Durham, NC (US); William G. Pagan, Durham, NC (US)

Correspondence Address: HOFFMAN WARNICK & DALESSANDRO LLC, 75 STATE STREET, 14TH FLOOR, ALBANY, NY, 12207, US

(21) Appl. No.: 11/560,027

(22) Filed: Nov. 15, 2006

(51) Int. Cl. H04L 9/32

(52) U.S. Cl. 713/186

(57) ABSTRACT

The invention provides a method and system for exchanging data between devices. In one embodiment, the invention includes a system for obtaining biometric data from a user; a system for using the biometric data as a secure key for encrypting and decrypting data; a system for transferring the secure key from a first device in contact with the user to a second device in contact with the user; and exchanging data between the first device and the second device, wherein the biometric data include biometric data from more than one source.

### BACKGROUND OF THE INVENTION

1. Technical Field

The invention relates generally to the exchange of data, and more particularly, to a method and system for exchanging data between devices across a biological interconnect, such as human skin.

2. Background Art

Personal electronic devices that are either wearable or easily portable have become ubiquitous. Often, an individual may carry two or more such devices, such as a personal digital assistant (PDA), cellular telephone, or portable computer. It is often necessary or desirable to transfer data from one such device to another, such as the transfer of a telephone number from a PDA to a cellular telephone or a digital certificate from a portable computer to a PDA. Wired transmission between devices using a physical connection, such as a universal serial bus (USB) cable, is burdensome and often not possible (e.g., where the devices require the use of incompatible physical connections). In the case that such data must be kept confidential, wireless transmission from one device to another is not desirable, as typical wireless transmissions are easily intercepted by third parties, even where the data are encrypted.

U.S. Patent Application Publication No. 20030128867 to Bennett, which is hereby incorporated by reference, discloses a device and method for biometric authentication using a personal electronic device, such as a cellular telephone. While such devices and methods may help to ensure that only authorized access to a device is granted, the exchange of data between such devices would still require the use of wired or wireless transmission.

To this extent, there is a need for methods and systems for the exchange of data that do not suffer from the defects known in the art.

### SUMMARY OF THE INVENTION

The invention provides a method and system for exchanging data between devices. In one embodiment, the invention includes a system for obtaining biometric data from a user; a system for using the biometric data as a secure key for encrypting and decrypting data; a system for transferring the secure key from a first device in contact with the user to a second device in contact with the user; and exchanging data between the first device and the second device, wherein the biometric data include biometric data from more than one source.

A first aspect of the invention provides a method for exchanging data between devices, the method comprising: obtaining biometric data from a user's body; using the biometric data as a secure key for encrypting and decrypting data; transferring the secure key from a first device held by the user to a second device held by the user; and exchanging data between the first device and the second device.

A second aspect of the invention provides a system for exchanging data between devices, the system comprising: a system for obtaining biometric data from a user; a system for using the biometric data as a secure key for encrypting and decrypting data; a system for transferring the secure key from a first device in contact with the user to a second device in contact with the user; and exchanging data between the first device and the second device.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawing that depicts an illustrative embodiment of the invention, in which:

FIG. 1 shows an illustrative method and system according to the invention.

It is noted that the drawing of the invention is not to scale. The drawing is intended to depict only typical aspects of the invention, and therefore should not be considered as limiting the scope of the invention.

### DETAILED DESCRIPTION

As indicated above, the invention provides a method and system for exchanging data using between devices.

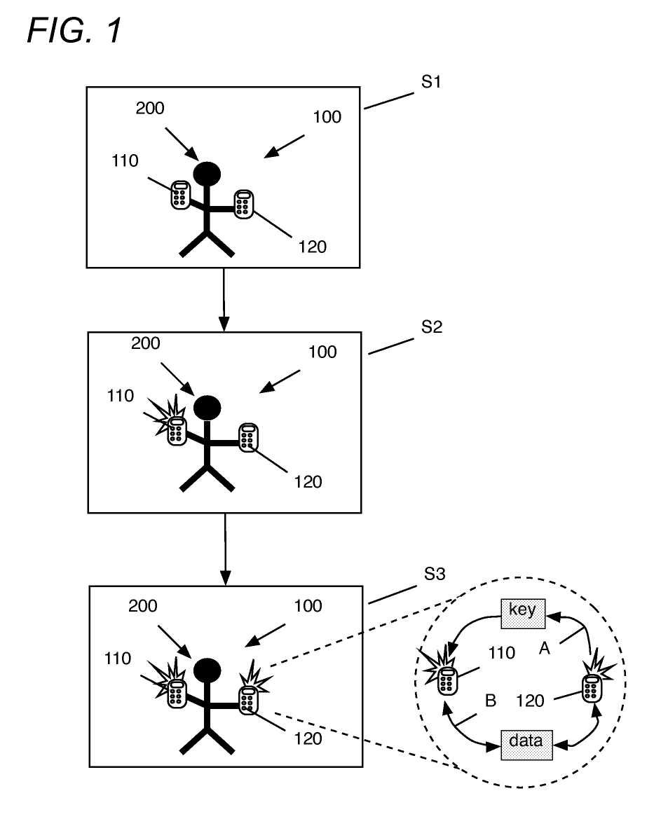

Turning now to the drawings, FIG. 1 shows an illustrative method and system 100 according to the invention. At step S1, a system 100 for exchanging data using a biological interconnect is shown comprising a first device 110 and a second device 120, each of which is operable to exchange data using a biological interconnect. Devices 110 and 120 are held by a user 200, whose body will provide the biological interconnect used by devices 110 and 120 to exchange data. In a preferred embodiment, the biological interconnect includes the skin of user 200.

In one embodiment, each device 110, 120 includes an apparatus for obtaining a biometric signal, such as that described in U.S. Patent Application Publication No. 20030128867, although other apparatuses may also be used. For example, each device 110, 120 may be operable to obtain biometric data from the body of user 200, which may then be used as a secure key for encrypting and decrypting data exchanged between devices 110 and 120.

Suitable biometric data include, for example, fingerprints, skin conductivity (which varies with stress level, for example), pulse rate, heartbeat waveform, etc. Other biometric data are possible, of course, and are within the scope of the invention. In some embodiments of the invention, more than one source of biometric data may be combined, as described in U.S. Patent Application Publication No. 20020138768 to Murakami et al., which is incorporated herein by reference.

An important aspect of the invention is that each device 110, 120 be operable to obtain or receive such biometric data, which permits the secure exchange of data between devices able to obtain or receive such biometric data (i.e., devices in physical contact with user 200). Third-party devices not in physical contact with user 200 are unable to obtain or receive such biometric data and are unable to use a secure key based on such biometric data to encrypt or decrypt data exchanged between device 110 and device 120. Thus, a significant limitation of known methods and systems is avoided.

In some embodiments of the invention, an apparatus for obtaining biometric data from the body of user 200 is separate from one or both devices 110, 120. In such an embodiment, the obtained biometric data is transferred from the separate apparatus to one or both devices 110, 120 and used as a secure key for encrypting and decrypting data, as described above.

Still referring to FIG. 1, at step S2, device 110 has obtained biometric data (e.g., heartbeat waveform, skin conductivity, pulse rate, etc.) from user 200. As described above, such biometric data may be used as a secure key for encrypting and decrypting data transferred between device 110 and another device operable to obtain or receive the same biometric data.

At step S3, device 120 has also obtained biometric data from user 200. Once device 110 and device 120 have each obtained biometric data from user 200, a secure key composed of such biometric data may be sent A from device 120 to device 110. Because device 110 has obtained the same biometric data from user 200, device 110 may use the secure key to encrypt and/or decrypt data exchanged B between device 110 and device 120.

As described above, user 200 (e.g., the skin of user 200) provides a secure channel, with or without encryption, based on biometric data obtained from user 200. Once each device involved in an exchange of data biometrically authenticates user 200, data may be exchanged securely in the context of Digital Rights Management (DRM) and/or authenticate credentials exchange, such as public key infrastructure (PKI) or electronic data interchange (EDI) signatures and certificates.

While FIG. 1 shows the secure exchange of data between two devices 110, 120 for purposes of illustration and brevity, it should be recognized that data may similarly be exchanged between more than two devices operable to obtain or receive biometric data from user 200.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for exchanging data between devices, the method comprising:
obtaining biometric data from a user's body;
using the biometric data as a secure key for encrypting and decrypting data;
transferring the secure key from a first device held by the user to a second device held by the user; and
exchanging data between the first device and the second device.

2. The method of claim 1, wherein the biometric data include biometric data from more than one source.

3. The method of claim 1, wherein obtaining includes obtaining biometric data using a device other than the first device and the second device.

4. The method of claim 1, exchanging includes exchanging data by wireless transmission.

5. A system for exchanging data between devices, the system comprising:
a system for obtaining biometric data from a user;
a system for using the biometric data as a secure key for encrypting and decrypting data;
a system for transferring the secure key from a first device in contact with the user to a second device in contact with the user; and
exchanging data between the first device and the second device.

6. The system of claim 5, wherein the biometric data include biometric data from more than one source.
